(19) United States
(12) Patent Application Publication
(10) Pub. No.: US 2025/0272147 A1
(43) Pub. Date: Aug. 28, 2025

(54) SCHEDULING SHARING OF COMPUTE RESOURCES BETWEEN WORKLOADS

(71) Applicant: Microsoft Technology Licensing, LLC, Redmond, WA (US)

(72) Inventors: Xenofon FOUKAS, Cambridge (GB); Bozidar RADUNOVIC, Cambridge (GB)

(21) Appl. No.: 18/657,449

(22) Filed: May 7, 2024

Related U.S. Application Data
(60) Provisional application No. 63/557,372, filed on Feb. 23, 2024.

(51) Int. Cl. G06F 9/50; G06F 9/455

(52) U.S. Cl. CPC G06F 9/5027; G06F 9/45558; G06F 2009/45595

(57) ABSTRACT

The present disclosure relates to systems, methods, and computer-readable media for implementing a scheduler for vRAN compute sharing. The systems described herein involve a real-time scheduling system that considers telemetry data associated with usage of vCPUs on a VM, container, or other service construct and determines estimated runtimes for tasks of workloads running on the vCPUs. The real-time scheduling system may generate scheduling instructions to be used by an operating system on the server device to schedule allocation of computing resources to any number of vCPUs hosted by the server device. The real-time scheduling system provides features that enables optimization of not only physical layer processing tasks, but a wholistic approach that involves optimizing scheduling of tasks associated with multiple processing layers of VMs, and particular vRAN workload VMs.

### CROSS REFERENCE TO RELATED APPLICATIONS

This application claims benefit and priority to Provisional Application No. 63/557,372, filed on Feb. 23, 2024, the entirety of which is incorporated herein by reference.

### BACKGROUND

Virtualized Radio Access Networks (vRANs) are part of the mobile network architecture that provides the wireless connectivity to mobile users in the form of base stations. In contrast to previous mobile network generations, in which base stations are typically implemented as specialized hardware boxes, modern mobile networks rely on fully virtualized RAN functions (e.g., in the form of containers), running on commodity x86 servers at the edge. Many vRAN workloads involve a real-time requirement in which processing of signals must be completed within a strict deadline. When this requirement is not met, services will often experience degraded performance and communications will often be dropped or become disconnected.

Avoiding performance degradation and disconnections is important in providing reliable telecommunication services, particularly since modern communication networks are often required to provide services at very high level of reliability with low latency. In order to ensure that a vRAN workload can meet these strict service requirements, a conventional approach within the industry is to use isolated compute resources such as dedicated compute cores, dedicated cache, dedicated RAM, and other computing resources in such a way that a machine on which a vRAN is running is equipped host the vRAN at its peak capacity.

While this overprovisioning of resources in accordance with demands of peak capacity ensures that a vRAN will effectively run during periods of peak capacity, it often becomes a very inefficient use of resources during other periods of time in which the vRAN is not running at peak capacity. Indeed, it is not uncommon that 80% of computing resources that are allocated to a VRAN workload are left unutilized, resulting in a very expensive network of devices that are only used at their peak capacity during relatively few periods of time. This results in significant power usage as well as a very robust computer network that is largely unutilized.

These and other drawbacks exist in modern telecommunications networks.

### BRIEF DESCRIPTION OF THE DRAWINGS

FIG. 1 illustrates an example telecommunications network environment including a real-time scheduling system implemented on a server device of an edge network.

FIG. 2 illustrates an example server device on which the real-time scheduling system can be implemented in accordance with one or more embodiments.

FIG. 3 illustrates an example implementation of the real-time scheduling system in which computing resources are scheduled for a set of workload tasks in accordance with one or more embodiments.

FIG. 4 illustrates an example implementation of the real-time scheduling system using a static scheduling approach in accordance with one or more embodiments.

FIG. 5 illustrates an example implementation of the real-time scheduling system using a dynamic scheduling approach in accordance with one or more embodiments.

FIG. 6 illustrates an example implementation of the real-time scheduling system in which tasks of multiple workloads are scheduled such that a compute core is idle during select processing periods in accordance with one or more embodiments.

FIG. 7 illustrates an example series of acts related to scheduling tasks across multiple processes in accordance with one or more embodiments.

FIG. 8 illustrates certain components that may be included within a computer system.

### DETAILED DESCRIPTION

This disclosure relates to sharing computing resources between a variety of workloads on a server node. In one or more embodiments described herein, the disclosure specifically relates to using a real-time scheduling system to coordinate and schedule computing resources between one or more virtual radio access network (vRAN) workloads and processes and one or more additional workloads (e.g., vRAN and/or non-vRAN workloads) for processes (e.g., virtual machines, containers, applications) also running on the same computing device. Indeed, as will be discussed in further detail below, a scheduler controller (referred to in some implementations as “a real-time scheduling system”) may be implemented on a server node to observe operating conditions of vCPUs of various processes (e.g., VMs). The scheduler controller may determine, based on telemetry data received for the processes, a predicted or estimated runtime that will be needed within a given processing period to perform a task of a workload.

Features and functionality of embodiments described herein provide examples and implementations that illustrate how the real-time scheduling system can generate scheduling instructions that an operating system (OS) scheduler can use in scheduling allocation of computing resources to multiple processes. The implementations described herein include features and functionality that optimize utilization of computing resources while ensuring that deadline-driven tasks (e.g., tasks of vCPU workloads) can be performed within strict deadlines.

As an illustrative example, a real-time scheduling system may receive telemetry data associated with a vCPU on a vRAN virtual machine. This telemetry data may provide information that may be used to determine one or more runtime durations associated with performing tasks of a workload. In one or more embodiments, the real-time scheduling system may additionally determine or otherwise identify one or more configuration parameters associated with the vRAN virtual machine and/or respective vCPUs of the vRAN virtual machine. The real-time scheduling system may generate scheduling instructions or other information that may be passed to an OS scheduler task(s) with allocating computing resources to vCPUs running on respective VMs (or other virtual servers, such as containers).

Virtualized Radio Access Networks (vRAN) are part of the mobile network architecture that provides the wireless connectivity to mobile users in the form of virtualized RAN components. Fifth generation (5G) mobile networks and beyond often utilize fully virtualized RAN (vRAN) functions (e.g., in the form of containers and/or virtual machines), running on commodity x86 servers at the edge. One characteristic of vRAN workloads is (soft) real-time requirement, e.g., the signal processing operation for a transmission and/or reception must be completed within a strict deadline (0.125 us-1 ms), otherwise users experience degraded performance at best or a complete disconnection from the network in the worst case.

Avoiding performance degradation is important for telecommunications networks as telecommunications networks (e.g., 5G networks) are required to provide services with very high levels of reliability (e.g., up to 5 nines) and low latency. To ensure that a vRAN component can meet these strict deadlines, a standard practice of the industry is to use isolated compute resources (dedicated CPU cores, dedicated cache and DRAM, etc.) and to provision the vRAN for peak capacity.

While isolated computing resources that are fully dedicated to corresponding virtual computing resources (e.g., vCPUs) is an effective way to streamline processing tasks and ensure a high measure of reliability, this can be an inefficient and overly expensive utilization of computing resources. Indeed, during non-peak periods in which traffic is not high, many computing resources will go unused when they could otherwise be shared with processes or VMs that are also hosted by a server device having the vRAN VMs thereon. This can be especially problematic with the often-bursty workload of network traffic (particularly in 5G networks), essentially forcing a significant number of computing resources to be reserved for vRAN services at all times.

Due to the isolated deployment configuration of the solutions that use dedicated deployment, conventional scheduling frameworks do not provide effective and/or reliable mechanism for the prediction of the CPU requirements of vRAN tasks at runtime. Moreover, there does not currently exist a framework in which a scheduler controller exists outside the VMs that is capable of analyzing telemetry associated with multiple processing layers to determine runtimes of various tasks and intelligently schedule the computing resources in a manner that allows unused CPU cores to be shared during periods of time when the vRAN is not using the CPU cores.

In the more general space of the cloud, there exist a number of scheduling frameworks for enabling the collocation of low-latency workloads. However, none of those solutions are aware of deadlines and the worst case execution time (WCET) of tasks, meaning that in the worst case the tail latency of processing vRAN tasks could still be high, leading to missed deadlines and low reliability (at most 3 nines). Moreover, most of those solutions require the collocated workloads to be implemented using specific constraining application programming interfaces (APIs), meaning that generic workloads running on containers or virtual machines (VMs) cannot be deployed on top of them. Finally, there exist a number of deadline scheduling framework solutions in the space of embedded systems. However, such solutions need to provide hard real-time guarantees (e.g., a deadline must never be missed) and therefore their design is based on the assumption that no other workload is running on the same hardware. If these assumptions are violated, these solutions would no longer work.

As will be discussed in further detail below, the present disclosure provides a real-time scheduling system that views vCPUs of different workloads of different services (e.g., VMs, containers), evaluates telemetry data that is agnostic to some of the individual processing details of the particular vRAN (e.g., without considering specific processing layers or that is isolated to the physical processing layer), and determines estimated runtime durations for different discrete computing periods. These estimations can be used to generate scheduling instructions that an OS scheduler can use in allocating computing resources between any number of vCPU threads independent of specific processing tasks and in a manner that optimizes allocation of physical computing resources between virtual components hosted by a server device.

As illustrated in the foregoing discussion and as will be discussed in further detail herein, the present disclosure utilizes a variety of terms to describe features and advantages of methods and systems described herein. Some of these terms will be discussed in further detail below.

As used herein, a cloud computing system or distributed computing system may be used interchangeably to refer to a network of connected computing devices that provide various services to computing devices (e.g., customer devices). For instance, as mentioned above, a cloud computing system can include a collection of physical server devices (e.g., server nodes) organized in a hierarchical structure including clusters, computing zones, virtual local area networks (VLANs), racks, fault domains, etc. In one or more embodiments described herein a portion of the cellular network (e.g., an edge network, datacenter) may be implemented in whole or in part on a cloud computing system. In one or more embodiments a data network may be implemented on the same or on a different cloud computing network as the portion of the cellular network. In addition, in one or more embodiments, a telecommunications network is implemented using services that are provided on server nodes of the cloud computing system.

As used herein, “telemetry data” refers to data that is logged or otherwise collected by an entity within a telecommunications network. For example, in one or more implementations described herein, telemetry data refers to any data that is collected by and/or received from a virtual machine in real-time. In one or more embodiments, the telemetry data may include observed or tracked runtimes of various tasks, which may be used to determine one or more runtime durations for a given vCPU, which will be discussed in further detail below. In one or more embodiments, telemetry data includes 3GPP telemetry data. In one or more implementations, telemetry data includes various key performance indicators (KPIs) (e.g., queue sizes, signal quality of UEs).

As used herein, a “configuration parameter” may refer to one or more parameters associated with limitations or functionality of a vCPU and/or associated vRAN virtual machine. In one or more embodiments, a configuration parameter indicates characteristics or requirements associated with performance of a task or workload. For example, in one or more embodiments, a configuration parameter includes indicated durations or deadlines associated with performance of a task. For instance, a configuration parameter may include a period parameter indicating a duration of time within which any given task can run using a vCPU. This duration of time may refer to a maximum time that can be configured or allocated to a vCPU to perform a discrete task. As another example, a configuration parameter may include a deadline parameter indicating a duration of time that is a maximum amount of time within which a specific task or a specific given task of a corresponding workload must be completed by a vCPU. In this instance, the deadline parameter may refer to a maximum period of time within a period parameter for which a given task must be performed. In one or more embodiments, the configuration parameters are received or otherwise obtained when a virtual machine is configured and may be based on the implementation and configuration of the vRAN virtual machine.

In one or more embodiments described herein a runtime duration is determined for a task. As used herein, a “runtime duration” may refer to a period of time for which a vCPU is assigned or allocated physical resources (e.g., CPU resources) to perform a given task (or tasks). For example, a runtime duration may refer to a subset of time or portion of time within a deadline parameter for which computing resources are made available to (e.g., allocated to) a vCPU and/or a vRAN generally. Additional detail associated with determining the duration and/or timing of the runtime duration will be discussed in connection with various examples below.

As used herein a workload includes a set of tasks, processes, or other computational activities that a vCPU executes in accordance with instructions. A workload may include any number of tasks, which may be performed in sequence or in parallel based on scheduling instructions associated with performing the workload (or tasks of the workload). Examples of tasks of a workload may include running applications, processing data, handling requests, and managing system resources. In one or more embodiments, tasks of a workload are in accordance with defined standards (e.g., 3GPP standards).

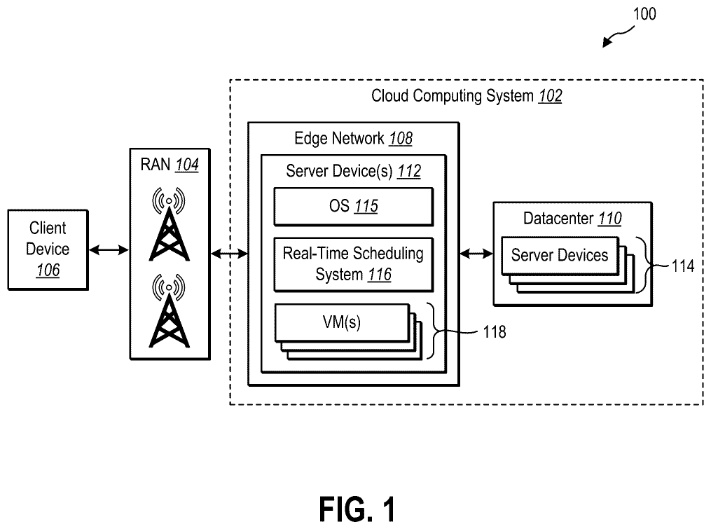

Additional detail will now be provided regarding systems described herein in relation to illustrative figures portraying example implementations. For example, FIG. 1 illustrates an example environment 100 for implementing features and functionality of a real-time scheduling system in accordance with examples described herein.

As shown in FIG. 1, the environment 100 may illustrate portions of a communication environment (e.g., a cellular network, such as a 5G cellular network). For example, the environment 100 may include zones or components of a cloud computing system 102, such as a radio access network (RAN) 104, core network, internal infrastructure, and other components of a cloud computing system 102. The components of the environment 100 may collectively form a public or private cellular network, which includes a RAN 104, core network, data network, and other components of a cloud computing system 102. In the example, shown, the environment includes a client device 106 (e.g., a user equipment, such as a mobile device), a RAN 104 including one or more physical RAN components (e.g., base stations), and different computing zones of a cloud computing system 102. In one or more embodiments described herein, the cloud computing system 102 includes server devices implemented on an edge network 108 and at a datacenter 110.

In the example shown, the cloud computing system 102 includes an edge network 108 having server device(s) 112 implemented thereon as well as a datacenter 110 having server devices 114 thereon. In this example, the server device(s) 112 on the edge network 108 includes an operating system (OS) 115, a real-time scheduling system 116, and a plurality of VMs 118. In one or more embodiments, the VMs 118 refer to vRANs that are implemented virtually on server devices of the cloud computing system 102 and which provide RAN functionality. Other implementations may involve core network components or other virtualized components of the cloud computing system 102 or mobile network generally.

In one or more embodiments, the server devices includes other types of services, such as containers, applications, or other service for which the real-time scheduling system 116 may facilitate scheduling tasks in accordance with one or more embodiments. Thus, while one or more embodiments described herein refer specifically to scheduling tasks on a variety of VM types (and specifically vRANs), it will be appreciated that other implementations may involve scheduling tasks on containers or other types of workload entities that may be implemented on server devices and/or which may include real-time scheduling of tasks and workloads.

In addition, while FIG. 1 illustrates an example environment 100 where the real-time scheduling system 116 is implemented on a server device 112 of an edge network 108, this is provided by way of example and not limitation. Indeed, while one or more embodiments described herein may involve the real-time scheduling system 116 being implemented on a device of an edge network 108, such as on a distributed unit having real-time processing requirements with strict deadlines within which packets need to be processed, other examples of the real-time scheduling system 116 may be implemented on devices of a core network, data network, edge network, or on any service of a telecommunications network (or other network that may be implemented on the cloud computing system 102) where the service(s) has tasks or workloads that have low latency or other time-sensitive requirements.

As mentioned above, the real-time scheduling system 116 may provide features and functionality related to scheduling tasks of workloads for various VMs on the server device 112 in a manner that enables computing resources to be shared between different vCPUs without causing certain deadlines to be missed. For example, as will be discussed in further detail herein, a real-time scheduling system 116 may receive telemetry data associated with a vCPU on a VM 118, determine duration(s) of task(s) to be performed by the VM 118, and generate scheduling instructions based on the determined duration(s) to enable an OS scheduler to efficiently schedule the tasks and to cause computing resources (e.g., physical cores (CPUs)) to be shared between vCPUs of multiple VMs 118.

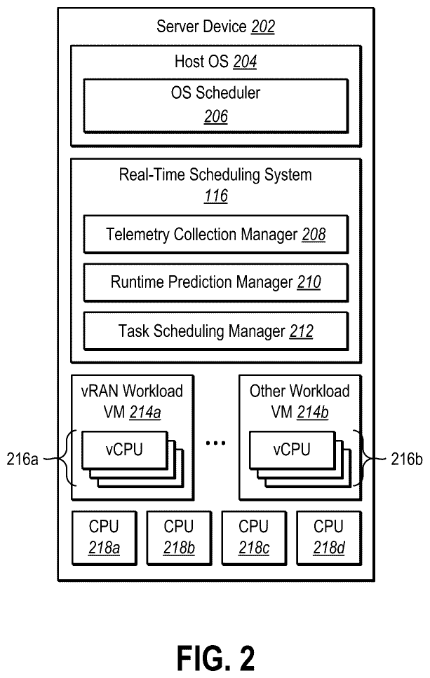

FIG. 2 provides a more detailed example of a server device 202 on which a real-time scheduling system 116 may be implemented in accordance with one or more embodiments. For example, as shown in FIG. 2, the server device 202 includes a host operating system (OS) 204 having an OS scheduler 206 (e.g., a deadline scheduler) implemented thereon. The host OS 204 may manage high level operations of any number of VMs hosted by the server device. For instance, the host OS 204 may manage a hypervisor on or associated with the OS 204, which may create and/or otherwise manage operation of the VMs on the server device 202. Among other things, the host OS 204 may include an OS scheduler 206 (or deadline scheduler) that is tasks with coordinating resources between one or more VMs that may share certain computing resources with other VMs.

For example, as shown in FIG. 2, the server device 202 is hosting a plurality of VMs (e.g., VMs 214a, 214b) of different types. A first set of VMs refers to vRAN workload VMs 214a, referred to herein as vRAN virtual machines having vCPUs 216a that have time-sensitive (e.g., deadline driven) workloads in which tasks must be performed within a hard deadline. In many cases, this involves processing communication packets that are being communicated and processed in real-time and which have protocols that define specific deadlines within which the packets need to be processed and/or transmitted. In one or more embodiments described herein, the real-time scheduling system 116 is particularly focused on ensuring that vRAN workload VMs 214a are performing tasks within deadlines as a priority and determining when computing resources that are tasked to perform processing tasks may have idle cycles or downtime that may be allocated to other (non-live) workloads (e.g., other workload VMs 214b).

A second set of VMs refers to other workload VMs 214b (e.g., non-real-time or simply non-vRAN workload VMs) having vCPUs 216b that may be associated with one or more of the physical cores (e.g., physical CPUs 218a-d) of the server device 202 for a given period of time to execute tasks of respective workloads. These workloads may or may not have specific deadlines within which processing tasks can be performed and thus have increased flexibility in scheduling tasks to be performed within periods of time. As will be discussed in further detail below, the tasks of these workloads may be performed across one or more periods of time and are therefore well-suited to be performed by physical cores that are being shared by vRAN workload VMs 214a.

As shown in FIG. 2, the server device 202 includes a real-time scheduling system 116 (or scheduling controller). As shown in FIG. 2, this real-time scheduling system 116 is not implemented as part of the respective VMs 214a-b. Thus, the real-time scheduling system 116 may not necessarily have detailed knowledge of specific tasks or threads that are performed by the vCPUs (e.g., vCPUs 216a-b), but rather evaluates telemetry data associated with the vCPUs themselves (e.g., without consideration of individual tasks or which processing layers are involved in performing specific tasks) to determine estimated runtimes that may be used in generating scheduling instructions for the various computing resources (e.g., CPUs 218a-d).

The real-time scheduling system 116 includes a number of components for performing features and functionality of implementations described herein. For example, the real-time scheduling system 116 includes a telemetry collection manager 208. The telemetry collection manager 208 may receive or otherwise obtain telemetry data from the VMs (e.g., vRAN workload VMs 214a and/or other workload VMs 214b). As used herein and consistent with explanation above, the telemetry data refers to any data associated with one or more vCPUs and parameters associated with operation of the vCPUs.

In one or more embodiments and in addition to other examples discussed herein, the real-time scheduling system 116 may determine, identify, or otherwise obtain configuration parameters, including a processing period (or simply period) associated with a vCPU or workload. A processing period may refer to a duration of time within which any discrete processing task is to be performed. In one or more embodiments, the period is a predetermined period of time determined by a vendor of the VM or specific vRAN function (e.g., vRAN component). By way of example, a period may refer to a fixed or predetermined period of time, such as 500 microseconds, 1 millisecond, or other duration of time as may serve a particular embodiment of an application, VM, or particular workload. In one or more embodiments, the processing period is referred to as a period parameter that is passed to the OS for use in performing scheduling operations and associating tasks with processing cycles of particular computing resources.

In one or more embodiments, the configuration parameters include a deadline associated with a duration of time in which a task must be performed to be considered successful. In the context of real-time functions (e.g., audio/video calls), a deadline is often a protocol-defined parameter indicating a specific duration of time in which a packet must be processed or in which a discrete task of a packet processing workload must be processed. In the event a deadline is not met, one or more packets can be dropped, service may be interrupted, or a session may be discontinued. In short, the real-time service will degrade and provide a notably worse experience for individuals or applications using the real-time application/services.

In one or more embodiments, the telemetry data includes runtime data (e.g., thread runtimes), which may refer to known or estimated runtimes for packets to be processed, as well as historical data associated with previous packet processing that has been collected and which may be used by the telemetry collection manager 208 in estimating future runtimes. In one or more embodiments, the telemetry data includes information about packets, such as a robustness of the packet, which may be indicative of a runtime (e.g., longer estimated runtimes for more robust packets, shorter estimated runtimes for less robust packets).

In addition to the above-examples, the telemetry data may refer to any information provided by the VMs to the telemetry collection manager 208 that may be used to determine a runtime for a given packet or task of a workload. This may include vCPU utilization information generally, RAN function data, thread runtimes, and other information associated with the vCPU generally. As noted above, the telemetry data may be agnostic to specific processes or processing layers and may be inclusive of information involving two or more processing layers, such as a physical layer (PHY), a radio resource allocation/reliability layer (MAC/RLC), a convergence/security layer (PDCP), a quality of service layer (SDAP), and a mobile core communication (NAS) layer.

It will be appreciated that the telemetry collection manager 208 may receive telemetry data from any number of VMs. For example, the telemetry collection manager may receive telemetry data from the vRAN workload VMs 214a in addition to the other workload VMs 214b.

As shown in FIG. 2, the real-time scheduling system 116 additionally includes a runtime prediction manager 210. The runtime prediction manager 210 may utilize the telemetry data and any other additional data accessible to the real-time scheduling system 116 to determine an estimated runtime (or runtime parameter) associated with an estimated time within a given period (and within a deadline) that a task is estimated to be completed. In one or more embodiments, the runtime prediction manager 210 determines runtime parameters for any number of tasks of an associated workload. For example, where processing a packet involves performing a set of tasks in a specific order or series, the runtime prediction manager 210 may determine a runtime for each of the tasks of the workload for the associated periods within which the tasks are to be performed. Where multiple vCPUs are involved, the runtime prediction manager may similarly determine runtimes for each of the tasks to be performed on each of the vCPUs.

The runtime prediction manager 210 may determine an estimated runtime in a variety of ways. For example, in one or more embodiments, the runtime prediction manager 210 generates or otherwise obtains a lookup table indicating runtimes for associated tasks based on information about the tasks/workload. In this example, certain tasks (e.g., common tasks) may have a known or predictable runtime that the runtime prediction manager 210 may identify from a lookup table with reasonable accuracy. Rather than calculate a runtime, the runtime prediction manager 210 may simply look it up and pass the runtime information to the OS scheduler 206 to use in scheduling the computing resources.

As another example, the runtime prediction manager 210 may use a conservative approach that involves simply determining whether a packet is to be processed within a given period (e.g., duration of computing cycle(s)). For example, where a packet exists and needs to be processed, the runtime prediction manager 210 may simply determine a maximum runtime value that tracks the duration parameter (or duration of the period) that would disallow computing resources of the vCPU performing the task(s) to be shared with other vCPUs from the same or different VMs. Alternatively, where a packet does not exist for a given period of time, the runtime prediction manager 210 may simply determine a minimum runtime value (e.g., a near-zero runtime value) that would allow computing resources to be shared with other vCPUs from the same or different VM for the vast majority or the entire duration of the period in which the runtime is set at the minimum value.

In one or more embodiments, the runtime prediction manager 210 uses a trained model, such as a machine learning model, in estimating runtimes for vCPU tasks. For example, in one or more embodiments, a machine learning model (or other form of dynamic prediction model(s)) receives historical telemetry data over time including information such as a type of task and associated runtime, which the machine learning model may use in training one or more algorithms to more accurately predict runtimes for similar types of tasks (or tasks having a certain set of characteristics).

As further shown in FIG. 2, the real-time scheduling system 116 includes a task scheduling manager 212. The task scheduling manager 212 may determine blocks of time within periods for which vCPUs will not be using allocated computing resources. For example, where a determined runtime parameter is only determined to be 20% of a given period, the task scheduling manager 212 may determine that the other 80% of the period may be shared with another vCPU.

In addition to simply determining specific blocks of available vCPU capacity, the task scheduling manager 212 may determine how many vCPUs are available over multiple periods. For example, in the event that a workload spans multiple periods and has a plurality of associated tasks to be performed in series, the task scheduling manager 212 may determine stretches of multiple periods in which one or more vCPUs if a given VM will be idle, which information may be used in generating scheduling instructions that may be passed to the OS scheduler 206.

As shown in FIG. 2, it will be appreciated that the real-time scheduling system 116 refers to a controller or off-OS scheduler that coordinates with the OS scheduler 206 to allocate computing resources between different workloads that may be performed using different vCPUs. This is beneficial in implementations where the OS scheduler 206 naively allocates computing resources to computing tasks as they are received rather than considering ordered tasks of multi-stage workloads that need to be completed within a given deadline. Indeed, by implementing the real-time scheduling system 116 that receives telemetry data from multiple VMs, the real-time scheduling system 116 can consider entire workflows and associated deadlines to assist the OS scheduler 206 in coordinating allocation of computing resources. This helps avoid scenarios in which the OS scheduler 206 naively or inefficiently assigns vCPUs to corresponding compute cores in a manner that causes processing delays or interruptions of services.

In addition to the above-details associated with determining estimated runtimes and generating instructions that enable the OS scheduler to determine an effective and efficient allocation of computing resources to respective vCPUs, other implementations may be performed in a similar manner as described in U.S. patent application Ser. No. 16/941,033, entitled “SHARING OF COMPUTE RESOURCES BETWEEN THE VIRTUALIZED RADIO ACCESS NETWORK (VRAN) AND OTHER WORKLOADS” filed on Jul. 28, 2020, the entirety of which is incorporated by reference.

By way of example and as discussed in the related disclosure, in one or more embodiments, the real-time scheduling system 116 and OS scheduler 206 may determine deadlines (e.g., runtime estimates) associated with vRAN workloads based on worst case execution times of individual processing tasks. In one or more embodiments, this is performed by observing vRAN traffic characteristics in real-time and determining estimated runtimes based on the observed traffic characteristics. As will be discussed in further detail below, in one or more implementations, the real-time scheduling system 116 implements or otherwise utilizes a real-time scheduling model including a machine learning model to predict the worst-case execution time. In one or more embodiments, the real-time scheduling model includes quantile decision trees to identify latency parameters (e.g., tail latency) of runtimes of individual tasks, which may be considered (e.g., in combination of a workload) to determine the estimated runtime(s).

In addition to worst case execution times, the real-time scheduling system 116 may take into account transmission deadlines for vRAN workloads when determining an order of varying tasks for the workloads. For example, the real-time scheduling system 116 and OS scheduler 206 may apply different levels of priority to vRAN workloads and ensure that certain tasks are performed or otherwise processed sooner that other tasks as soon as processing resources (e.g., CPUs) become available. In the event that a task is taking longer than expected, the real-time scheduling system 116 may dynamically increase the quantity of computing resources that are allocated to a vRAN VM (or individual vCPUs) to ensure that the task is completed by a transmission deadline.

In one or more embodiments, the real-time scheduling system 116 and OS scheduler 206 make scheduling decisions and generate scheduling instructions in accordance with a predetermined time interval. For example, in one or more embodiments, scheduling decisions are made every 20 microseconds, which allows the real-time scheduling system 116 and/or OS scheduler to intervene and proactively acquire more CPU cores for a particular vCPU (or VM) where the vCPU is on track to miss a deadline (e.g., due to a misprediction of the expected CPU requirements).

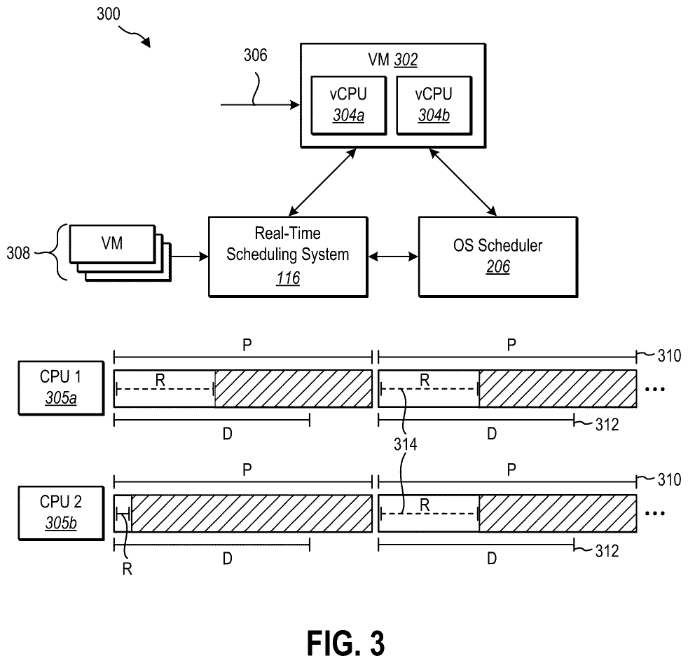

Additional detail will now be discussed in connection with various example implementations in which the real-time scheduling system 116 may implement effective scheduling of computing resources between one or more VMs including vRAN workload VMs as well as other types of workload VMs (e.g., non-real-time workload VMs). For example, FIGS. 3-6 illustrate example implementations in which the real-time scheduling system 116 (e.g., a task scheduling manager 212) determines estimated runtimes that may be used in a variety of ways to facilitate efficient and effective allocation of computing resources to one or more vCPUs.

For example, FIG. 3 illustrates an example implementation in which a real-time scheduling system 116 determines an estimated runtime based on telemetry data and cooperatively schedules computing resources (e.g., CPUs 305a-b) for vCPUs 304a-b of a VM 302 to perform various workload tasks. In particular, FIG. 3 illustrates an example workflow 300 in which the real-time scheduling system 116 coordinates scheduling of processing resources (e.g., CPUs 305a-b) for a first vCPU 304a and a second vCPU 304b on a VM 302 (e.g., a real-time vRAN VM). In this example, the VM 302 receives packets 306 to be processed using two vCPUs 304a-b. Other implementations may include fewer or additional vCPUs. As discussed above, in one or more embodiments, the real-time scheduling system 116 is only aware of the vCPUs generally and does not have an awareness of specific tasks or processing layers involved in execution of the tasks by the respective vCPUs. In contrast to conventional approaches, this provides the real-time scheduling system 116 with a thread-agnostic approach that enables the real-time scheduling system 116 to determine estimated runtimes and generate scheduling instructions that take into account more than simply a physical layer, but rather takes a more wholistic approach in which tasks performed in connection with any number of multiple processing layers are considered in generating or otherwise determining scheduling instructions.

As shown in FIG. 3, the VM 302 provides telemetry data to the real-time scheduling system 116. In addition to the telemetry data from the VM, the real-time scheduling system 116 receives telemetry data from one or more additional VMs 308 on the server device. The VMs 308 may include a combination of vRAN workload VMs and non-vRAN workload VMs (or other non-real-time workload VMs). In one or more embodiments, the real-time scheduling system 116 identifies configuration parameters including, by way of example, period parameters 310 and deadline parameters 312, and may further consider runtime data, vRAN data, and any other information to determine estimated runtime(s) 314 and generating scheduling instructions. As shown in FIG. 3, the real-time scheduling system 116 may provide scheduling instructions to the OS scheduler 206. The OS scheduler 206 may schedule or otherwise allocate computing resources to the vCPUs 304a-b of the VM 302 in accordance with the scheduling instructions.

As further shown in FIG. 3, a sequence of processing cycles are shown. In this example, the first vCPU 304a may be scheduled to execute first and second tasks within first and second periods, respectively. As shown in FIG. 3, each of the periods have determined deadlines associated with a maximum amount of time within the period during which a corresponding vRAN task (or multiple tasks, such as a series of tasks of a workload) must be performed. As further shown, an estimated runtime is determined, which is well short of the deadline. In this example, each of the periods include blocks of time in which the vCPU will not need computing resources of a physical core allocated to the vCPU.

As further shown in FIG. 3, a second vCPU 304b may be scheduled to execute first and second tasks (or first and second workloads) within the first and second periods, respectively. For instance, the periods may refer to periods in which packets will be processed. Due to the nature of the workload, this example shows a first period in which a task is not scheduled for the second vCPU 304b while a task is scheduled for the second vCPU 304b during a second period. In this example, the second vCPU 304b will not need computing resources of a physical core for the first period. In addition, the second vCPU 304b may not need computing resources for the entire duration of the second period.

In this example, the real-time scheduling system 116 may consider these down times (e.g., periods in which the vCPU will not be using the physical core(s)) in determining whether one or more tasks of other processes may be scheduled using the computing resources associated with the vCPUs during the respective periods. In one or more embodiments, the real-time scheduling system 116 determines scheduling instructions indicating that one or more tasks of other vCPUs (e.g., of non-real-time workloads) that may be performed during these limited periods of time. Where certain workloads may require multiple periods to be available in sequence, these blocks of unused computing resources may or may not provide a useful resource. However, where certain workloads may be broken up into smaller tasks or where certain tasks only need the smaller blocks of time, the real-time scheduling system 116 may generate scheduling instructions that the host OS will use in coordinating sharing of the computing resources between different vCPUs (e.g., of the same or different VMs) for the portions of the periods in which the vRAN VM is predicted to not need the computing resources.

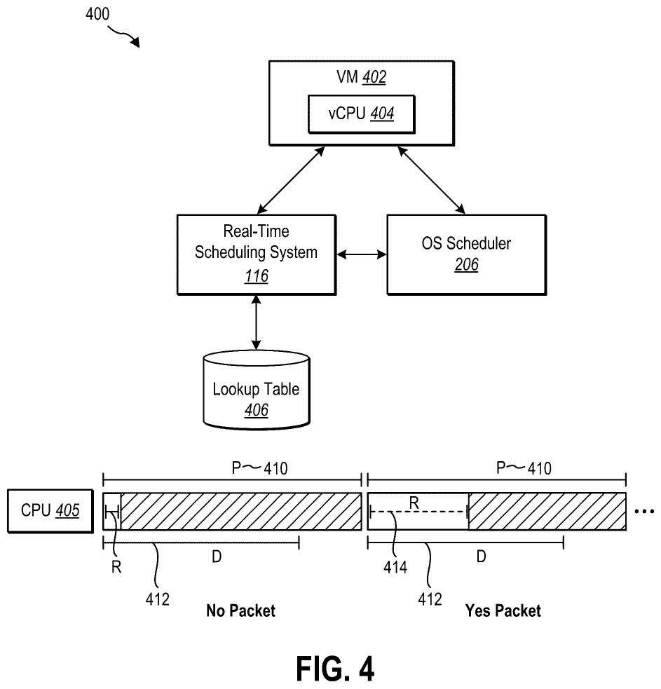

Moving on, FIG. 4 provides another example involving a VM, real-time scheduling system, and OS scheduler similar to the components described above in connection with FIG. 3. In particular, FIG. 4 illustrates an example workflow 400 in which a real-time scheduling system uses a lookup table 406 in coordinating scheduling of computing resources (e.g., CPU 405) for a vCPU 404 of a VM 402 (e.g., a real-time vRAN VM). In this example, the VM 402 receives packets to be processed. The real-time scheduling system 116 receives telemetry data from the VM 402 (and/or other VMs hosted by the server device).

Similar to one or more embodiments described above, the real-time scheduling system 116 may obtain configuration parameters (e.g., period parameters 410, deadline parameters 412) and any additional information that enables the real-time scheduling system 116 estimated runtimes 414 to use in generating and providing scheduling instructions to the OS scheduler 206. The OS scheduler 206 may then allocate computing resources (e.g., CPU 405) to respective tasks of a workload for the VM 402.

In this example, the real-time scheduling system 116 implements a static (and conservative) approach to scheduling resources for a vCPU 404 on the VM 402. For instance, in the illustrated example, the real-time scheduling system 116 determines an estimated runtime for a first period and an estimated runtime for a second period. In this example, the real-time scheduling system 116 determines that a packet is not to be processed for a first period while a packet is to be processed for a second period. In this implementation, the size or robustness of the packet may be ignored or otherwise not considered in determining the runtime parameter. Rather, all that may be considered in this implementation is whether the vCPU 404 is to perform a task within a given period associated with a given period parameter.

As shown in FIG. 4, the real-time scheduling system 116 determines the first runtime parameter to be a minimum length (e.g., 0 seconds or close to 0 seconds) based on a determination that the vCPU 404 of the VM 402 is not going to need any computing resources to execute a task. In this example, the computing resource may be shared in its entirety with another vCPU (on the same or different VM). In contrast, the real-time scheduling system 116 determines the second runtime parameter to be a maximum length (e.g., the entire period or the entire deadline duration). In this example, the computing resource may be reserved entirely for the vCPU 404 of the VM 402 even where the vCPU 404 can execute the task with prior to expiration of the deadline (e.g., with time to spare). This provides a simple and useful approach, particularly in the event that historical telemetry data is unavailable or in the event where predicting a runtime parameter is difficult for one or more packets for some reason or another.

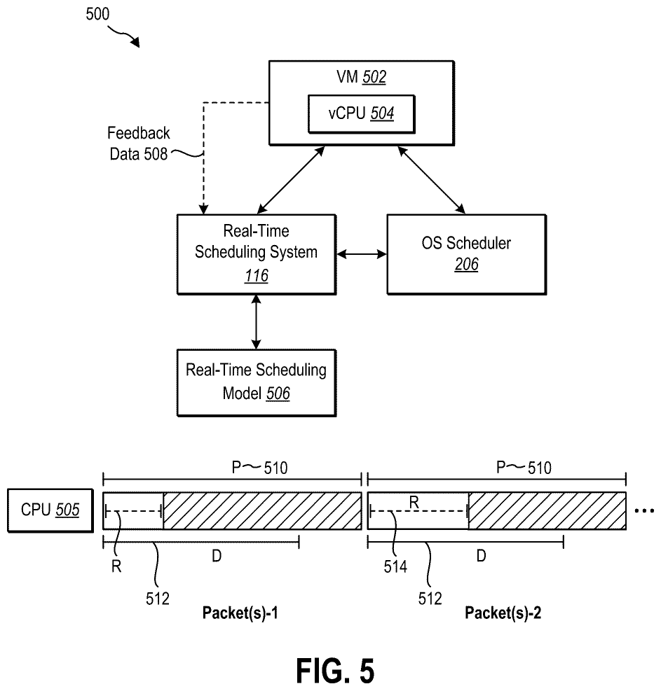

Moving on, FIG. 5 illustrates an example implementation showing a more dynamic approach to determining a runtime parameter. In particular, FIG. 5 illustrates an example workflow 500 in which the real-time scheduling system 116 utilizes a real-time scheduling model 506 (e.g., a machine learning model) to coordinate scheduling of computing resources (e.g., CPU 505) for a vCPU 504 on a VM 502 (e.g., a real-time vRAN VM). In this example, the VM 502 receives packets and the real-time scheduling system 116 receives telemetry data (from the VM and other VMs). The real-time scheduling system 116 may additionally obtain configuration parameters (e.g., period parameters 510, deadline parameters 512) and any other information that may be used by the real-time scheduling system 116 to determine estimated runtimes 514. The real-time scheduling system 116 may generate and provide scheduling instructions to the OS scheduler 206, which uses the scheduling instructions to coordinate allocation of computing resources (e.g., CPU 505) between the vCPU 504 of the VM 502 and one or more additional vCPUs on VMs hosted by a server device (and/or other vCPUs of the VM 502).

In contrast to the previous example shown in FIG. 3, the real-time scheduling system 116 includes a real-time scheduling model 506 (e.g., a machine learning model or other prediction model) that is trained to generate an output of a predicted runtime based on an input including a set of telemetry data. Similar to one or more embodiments described herein, the real-time scheduling model 506 may consider telemetry data of VMs generally with regard to individual vCPUs based on data that is agnostic or independent from the specific processing layers of the vRAN.

As shown in FIG. 5, the real-time scheduling system 116 may update or refine the prediction model over time. For example, as shown in FIG. 5, the real-time scheduling system 116 may receive feedback data 508 from the VM 502 indicating actual runtimes associated with performing various tasks. In the event that the actual runtimes differ from the predicted runtimes, the real-time scheduling system 116 may cause the real-time scheduling model 506 to be refined or otherwise fine-tuned in order to better emulate actual deadlines indicated by the feedback data 508. Over time the prediction model will likely become more accurate, which will allow for more confident scheduling of tasks and coordinating sharing of computing resources between vCPUs on the server device.

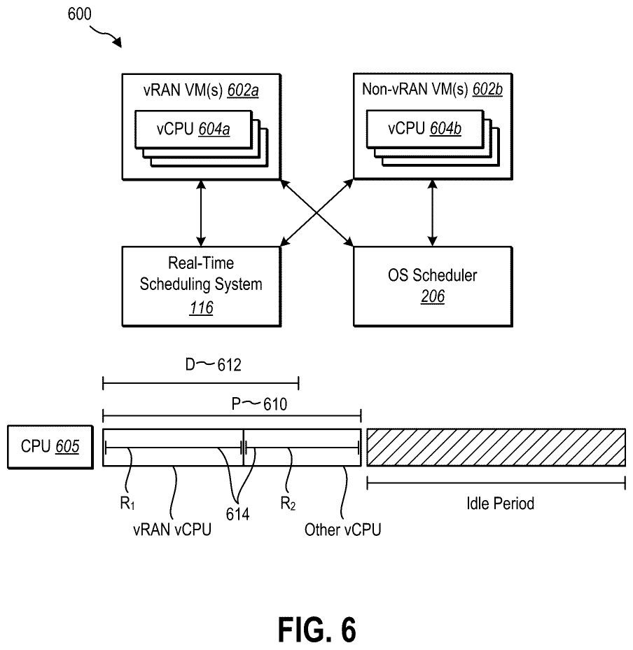

FIG. 6 provides another example showing a possible implementation of the real-time scheduling system 116 in accordance with one or more embodiments. In particular, FIG. 6 illustrate an example workflow 600 in which the real-time scheduling system 116 coordinates scheduling of computing resources (e.g., CPU 605) between one or more vCPUs 604a of a vRAN VM 602a and one or more vCPUs 604b of non-vRAN VMs 602b. In this example, the real-time scheduling system 116 interacts with two VMs (and/or multiple VMs of different types). For example, a first VM 602a is a vRAN VM while a second VM 602b is a non-vRAN VM. Other implementations may include more than one vRAN VMs, multiple non-vRAN VMs, and/or additional VMs of different types. Similar to other examples above, the VMs 602a-b provide telemetry data to the real-time scheduling system 116. The real-time scheduling system 116 may additionally obtain configuration parameters (e.g., period parameter(s) 610, deadline parameter(s) 612) and any other information which may be used to determine estimated runtimes 614 and generate scheduling instructions that the OS scheduler 206 can use to allocate computing resources (e.g., CPU 605) between vCPUs 604a-b.

In this example, the real-time scheduling system 116 and/or OS scheduler 206 may coordinate to group tasks within common periods while allowing certain processing cycles to remain idle. In this way, the real-time scheduling system 116 may enable workload tasks to be done in a time-efficient manner while also reducing the amount of power consumption on the server device. This can lengthen the life of the physical cores as well as significantly reduce power consumption across devices of the cloud.

As noted above, while one or more embodiments described herein refer specifically to vCPUs on VMs that are hosted by a server device, features of the real-time scheduling system 116 and the OS scheduler 206 may be implemented in connection with any container-based environment. For example, in one or more embodiments, multiple threads can be grouped together as part of a processing group and the real-time scheduling system may determine parameters (e.g., period, deadline, runtime parameters) for the processing group collectively rather than determining these parameters for individual threads (e.g., vCPUs). In this example, a processing grouping may refer to one or more threads or vCPUs of a specific VM or container. Thus, while one or more embodiments described above refer to scheduling computing resources for individual vCPUs, the real-time scheduling system may similarly assist in scheduling computing resources for groupings of vCPUs (e.g., groupings of processing threads, or a group of associated vCPUs of a VM).

Moreover, while each of the workflows and respective environments shown in FIGS. 3-6 illustrate different implementations of the real-time scheduling system 116, it will be appreciated that none of these implementations are intended to be limiting or self-contained to specific implementations. For example, features of each of the implementations shown in FIGS. 3-6 may be performed in combination with features of other implementations. For example, the real-time scheduling system 116 may simultaneously group tasks within specific periods (as shown in FIG. 6) while also implementing a dynamic prediction model (as shown in FIG. 5).

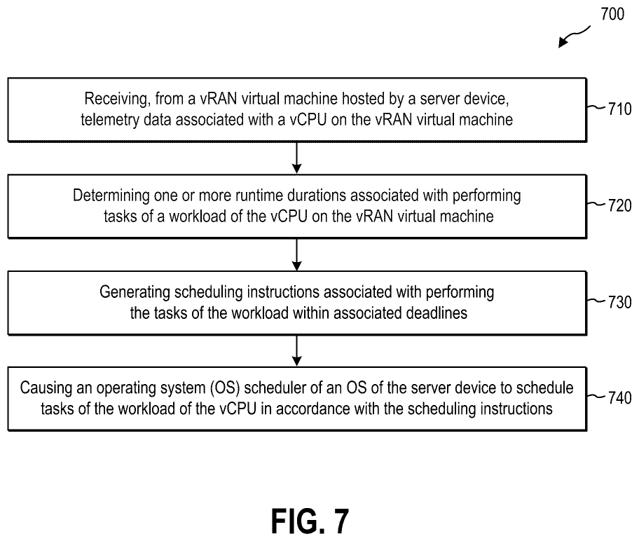

Turning now to FIG. 7, this figure illustrates an example flowchart including a series of acts 700 for intelligently scheduling tasks to be performed in connection with vRAN workloads on a server device involving multiple vCPUs. In particular, FIG. 7 illustrates a series of acts 700 in which a real-time scheduling system determines estimated runtime(s) and coordinates scheduling of tasks with an operating system in a manner that enables compute cores to be shared without missing processing deadlines (e.g., packet processing deadlines). While FIG. 7 illustrates acts 700 according to one or more embodiments, alternative embodiments may omit, add to reorder, and/or modify any of the acts 700 shown in FIG. 7. The acts 700 of FIG. 7 may be performed as part of a method. Alternatively, a non-transitory computer-readable medium can include instructions thereon that, when executed by one or more processors, cause a server device and/or client device to perform the acts 700 of FIG. 7. In still further embodiments, a system can perform the acts 700 of FIG. 7.

As shown in FIG. 7, a series of acts 700 includes an act of receiving, from a vRAN virtual machine hosted by a server device, telemetry data associated with a vCPU on the vRAN virtual machine. The series of acts 700 additionally includes an act 720 of determining one or more runtime durations associating performing tasks of a workload of the vCPU on the vRAN virtual machine. In one or more embodiments, the act 720 includes determining, based at least in part on the telemetry data received from the vRAN virtual machine, one or more runtime durations associated with performing tasks of a workload of the vCPU on the vRAN virtual machine.

The series of acts 700 further includes an act 730 of generating scheduling instructions associated with performing the tasks of the workload within associated deadlines. In one or more embodiments, the act 730 includes generating scheduling instructions for the vRAN virtual machine to perform the tasks of the workload within the determined one or more runtime durations.

The series of acts 700 also includes an act 740 of causing an operating system (OS) scheduler of an OS of the server device to schedule the tasks of the workload of the vCPU in accordance with the scheduling instructions. In one or more embodiments, the act 740 includes causing an operating system (OS) scheduler of an OS of the server device to schedule the tasks of the workload of the vCPU in accordance with the scheduling instructions.

In one or more embodiments, the series of acts 700 includes an act of determining one or more configuration parameters associated with the vRAN virtual machine. In one or more embodiments, the one or more configuration parameters includes parameters associated with characterizations and features of the workload of the vCPU. The one or more configuration parameters may include a period parameter indicating a first duration of time within which any given task can run using the vCPU. The one or more configuration parameters may additionally include a deadline parameter indicating a second duration of time less than or equal to the first duration of time indicating a maximum time within which a given task of a corresponding workload must be completed using the vCPU. In one or more embodiments, the one or more runtime durations are determined based on a robustness of an associated task of the workload.

In one or more embodiments, the telemetry data includes utilization data of multiple processing layers associated with the vRAN virtual machine. In one or more embodiments, the multiple processing layers includes two or more of a physical layer (PHY), a radio resource allocation/reliability layer (MAC/RLC), a convergence/security layer (PDCP), a quality of service layer (SDAP), and a mobile core communication (NAS) layer. In one or more embodiments, the telemetry data includes 3GPP telemetry data and one or more key performance indicators (KPIs) associated with utilization of the vRAN virtual machine.

In one or more embodiments, the series of acts 700 includes generating a lookup table indicating runtimes for associated tasks based on historical telemetry data received from one or more vRAN virtual machines. In one or more embodiments, determining the one or more runtime durations is based on information contained within the lookup table.

In one or more embodiments, the series of acts 700 optionally includes receiving, from a second virtual machine hosted by the server device, additional telemetry data associated with a second vCPU on the second virtual machine. The series of acts 700 may also include determining, based at least in part on the additional telemetry data received from the second virtual machine, one or more runtime durations associated with performing tasks of a second workload of the second vCPU on the second virtual machine. The series of acts 700 may also include generating additional scheduling instructions for the second virtual machine to perform tasks of the second workload. The series of acts 700 may also include causing the OS scheduler of the OS of the server device to schedule the tasks of the second workload of the second vCPU in accordance with the additional scheduling instructions. It will be appreciated that data need not be collected from non-real-time VMs to effectively generate scheduling instructions in accordance with one or more embodiments; however, obtaining and using this data may enable further optimizing and scheduling workloads and associated tasks.

In one or more embodiments, the tasks of the second workload are scheduled to be performed by a same physical CPU as a CPU selected to execute the tasks of the workload of the vCPU. In one or more embodiments, the second virtual machine is a non real-time virtual machine in which the second workload has a more flexible deadline parameter (e.g., no specific deadline(s)) than a deadline parameter of the workload of the vCPU on the vRAN virtual machine.

In one or more embodiments, the telecommunications network is a 5G mobile network. In one or more embodiments, the operating system is an operating system of a distributed unit, and wherein the server device is implemented on an edge zone of the telecommunications network.

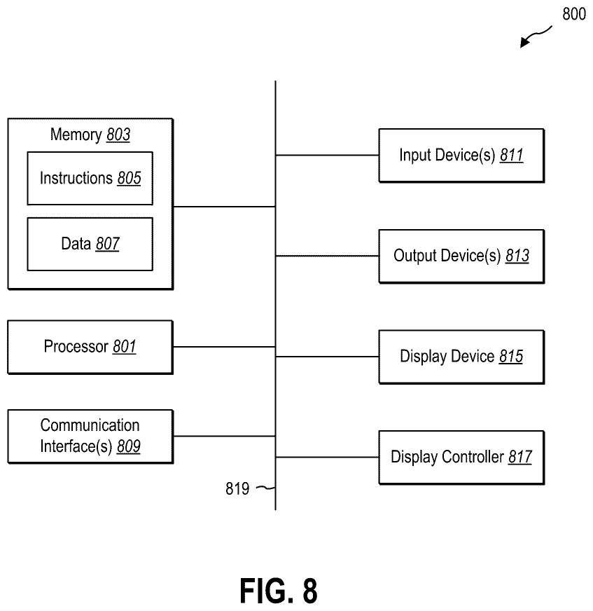

FIG. 8 illustrates certain components that may be included within a computer system 800. One or more computer systems 800 may be used to implement the various devices, components, and systems described herein.

The computer system 800 includes a processor 801. The processor 801 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during execution of the instructions 805 by the processor 801.

A computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 800 may also include one or more input devices 811 and one or more output devices 813. Some examples of input devices 811 include a keyboard, mouse, microphone, remote control device, button, joystick, trackball, touchpad, and lightpen. Some examples of output devices 813 include a speaker and a printer. One specific type of output device that is typically included in a computer system 800 is a display device 815. Display devices 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. In a telecommunications network including virtualized radio access network (vRAN) components running on servers of the telecommunications network, a method comprising:
receiving, from a vRAN virtual machine hosted by a server device, telemetry data associated with a vCPU on the vRAN virtual machine;
determining, based at least in part on the telemetry data received from the vRAN virtual machine, one or more runtime durations associated with performing tasks of a workload of the vCPU on the vRAN virtual machine;
generating scheduling instructions for the vRAN virtual machine to perform the tasks of the workload within the determined one or more runtime durations; and
causing an operating system (OS) scheduler of an OS of the server device to schedule the tasks of the workload of the vCPU in accordance with the scheduling instructions.

2. The method of claim 1, further comprising determining one or more configuration parameters associated with the vRAN virtual machine, the one or more configuration parameters including:
a period parameter indicating a first duration of time within which any given task can run using the vCPU; and
a deadline parameter indicating a second duration of time less than or equal to the first duration of time indicating a maximum time within which a given task of a corresponding workload must be completed using the vCPU.

3. The method of claim 1, wherein the telemetry data includes utilization data of multiple processing layers associated with the vRAN virtual machine.

4. The method of claim 3, wherein the telemetry data includes 3GPP telemetry data and one or more key performance indicators (KPIs) associated with utilization of the vRAN virtual machine.

5. The method of claim 3, wherein the multiple processing layers includes two or more of a physical layer (PHY), a radio resource allocation/reliability layer (MAC/RLC), a convergence/security layer (PDCP), a quality of service layer (SDAP), and a mobile core communication (NAS) layer.

6. The method of claim 1, wherein the one or more runtime durations are determined based on a robustness of an associated task of the workload.

7. The method of claim 1, further comprising:
generating a lookup table indicating runtimes for associated tasks based on historical telemetry data received from one or more vRAN virtual machines,
wherein determining the one or more runtime durations is based on information contained within the lookup table.

8. The method of claim 1, further comprising:
receiving, from a second virtual machine hosted by the server device, additional telemetry data associated with a second vCPU on the second virtual machine;
determining, based at least in part on the additional telemetry data received from the second virtual machine, one or more runtime durations associated with performing tasks of a second workload of the second vCPU on the second virtual machine;
generating additional scheduling instructions for the second virtual machine to perform tasks of the second workload; and
causing the OS scheduler of the OS of the server device to schedule the tasks of the second workload of the second vCPU in accordance with the additional scheduling instructions.

9. The method of claim 8, wherein the tasks of the second workload are scheduled to be performed by a same physical CPU as a CPU selected to execute the tasks of the workload of the vCPU.

10. The method of claim 8, wherein the second virtual machine is a non real-time virtual machine.

11. The method of claim 1, wherein the telecommunications network is a 5G mobile network.

12. The method of claim 1, wherein the operating system is an operating system of a distributed unit, and wherein the server device is implemented on an edge zone of the telecommunications network.

13. In a telecommunications network including virtualized radio access network (vRAN) components running on servers of the telecommunications network, a method comprising:
receiving, from a vRAN virtual machine hosted by a server device, telemetry data associated with a plurality of vCPUs on the vRAN virtual machine;
determining, based at least in part on the telemetry data received from the vRAN virtual machine, a plurality of runtime durations associated with performing tasks of a workload of the plurality of vCPUs on the vRAN virtual machine;
generating scheduling instructions for the vRAN virtual machine to perform the tasks of the workload within the determined plurality of runtime durations; and
causing an operating system (OS) scheduler of an OS of the server device to schedule the tasks of the workload across the plurality of vCPUs in accordance with the scheduling instructions.

14. The method of claim 13, further comprising determining one or more configuration parameters associated with the vRAN virtual machine, the one or more configuration parameters including:
a period parameter indicating a first duration of time within which any task can run using a given vCPU; and
a deadline parameter indicating a second duration of time less than or equal to the first duration of time indicating a maximum time within which a given task of a corresponding workload must be completed using the given vCPU.

15. The method of claim 13, wherein the telemetry data includes utilization data of multiple processing layers associated with the vRAN virtual machine, the multiple processing layers including two or more of a physical layer (PHY), a radio resource allocation/reliability layer (MAC/RLC), a convergence/security layer (PDCP), a quality of service layer (SDAP), and a mobile core communication (NAS) layer.

16. The method of claim 13, further comprising:
generating a lookup table indicating runtimes for associated tasks based on historical telemetry data received from one or more vRAN virtual machines,
wherein determining the plurality of runtime durations is based on information contained within the lookup table.

17. The method of claim 13, wherein the operating system is an operating system of a distributed unit, and wherein the server device is implemented on an edge zone of a 5G mobile network.

18. A system, comprising:
at least one processor;
memory in electronic communication with the at least one processor; and
instructions stored in the memory, the instructions being executable by the at least one processor to:
receive, from a vRAN virtual machine hosted by a server device, telemetry data associated with a vCPU on the vRAN virtual machine;
determine, based at least in part on the telemetry data received from the vRAN virtual machine, one or more runtime durations associated with performing tasks of a workload of the vCPU on the vRAN virtual machine;
generate scheduling instructions for the vRAN virtual machine to perform the tasks of the workload within the determined one or more runtime durations; and
cause an operating system (OS) scheduler of an OS of the server device to schedule the tasks of the workload of the vCPU in accordance with the scheduling instructions.

19. The system of claim 18, further comprising determining one or more configuration parameters associated with the vRAN virtual machine, the one or more configuration parameters including:
a period parameter indicating a first duration of time within which any given task can run using the vCPU; and
a deadline parameter indicating a second duration of time less than or equal to the first duration of time indicating a maximum time within which a given task of a corresponding workload must be completed using the vCPU.

20. The system of claim 18, wherein the telemetry data includes utilization data of multiple processing layers associated with the vRAN virtual machine, the multiple processing layers including two or more of a physical layer (PHY), a radio resource allocation/reliability layer (MAC/RLC), a convergence/security layer (PDCP), a quality of service layer (SDAP), and a mobile core communication (NAS) layer.
